(19) United States
(12) Patent Application Publication
(10) Pub. No.: US 2011/0148937 A1
(43) Pub. Date: Jun. 23, 2011

(54) PIXEL CIRCUIT, ORGANIC LIGHT EMITTING DISPLAY, AND METHOD OF CONTROLLING BRIGHTNESS THEREOF

(75) Inventors: Dong-Wook PARK, Yongin-City (KR); Keum-Nam Kim, Yongin-City (KR)

(73) Assignee: Samsung Mobile Display Co., Ltd., Yongin-city (KR)

(21) Appl. No.: 12/759,131

(22) Filed: Apr. 13, 2010

(30) Foreign Application Priority Data
Dec. 17, 2009 (KR) 10-2009-0126116

(51) Int. Cl. G09G 5/10

(52) U.S. Cl. 345/690; 345/76

(57) ABSTRACT

An organic light emitting display apparatus having a pixel circuit, the pixel circuit including an organic light emitting diode (OLED); a capacitor having a first terminal connected to a first node, and a second terminal connected to an anode electrode of the OLED; a switching transistor having a gate electrode connected to a scanning line, a first electrode connected to a data line, and a second electrode connected to the first node; and a driving transistor having a first gate electrode connected to the first node, a first electrode connected to a first power supply, a second electrode connected to the anode electrode of the OLED, and a second gate electrode connected to a common voltage line.

### CROSS-REFERENCE TO RELATED APPLICATION

This application claims the benefit of Korean Patent Application No. 10-2009-0126116, filed on Dec. 17, 2009, in the Korean Intellectual Property Office, the disclosure of which is incorporated herein in its entirety by reference.

### BACKGROUND OF THE INVENTION

1. Field of the Invention

Aspects of the present invention relate to a pixel circuit, an organic light emitting display apparatus including the pixel circuit, and a method of controlling brightness of the organic light emitting display apparatus.

2. Description of the Related Art

Flat panel display devices such as liquid crystal displays (LCDs), plasma display panels (PDPs), or field emission displays (FEDs) have been developed, which have overcome the disadvantages of cathode ray tubes (CRTs). Among these display devices, organic light emitting display apparatuses are deemed as the next-generation displays for their excellent light emitting efficiency, brightness, and viewing angle, and high response speed.

The organic light emitting display apparatuses display an image by using an organic light emitting diode (OLED) that emits light that is generated when electrons and holes are recombined. The organic light emitting display apparatuses have a high response speed and consume low amounts of power when driven.

### SUMMARY OF THE INVENTION

An aspect of the present invention provides a pixel circuit which is capable of controlling a current supplied to an organic light emitting diode (OLED) by applying a common voltage to a second gate electrode of a driving transistor having a double gate structure, an organic light emitting display apparatus, and a method of controlling brightness of the organic light emitting display apparatus.

According to an aspect of the present invention, there is provided a pixel circuit comprising: an organic light emitting diode (OLED); a capacitor, wherein a first terminal of the capacitor is connected to a first node, and a second terminal of the capacitor is connected to an anode electrode of the OLED; a switching transistor, wherein a gate electrode of the switching transistor is connected to a scanning line, a first electrode of the switching transistor is connected to a data line, and a second electrode of the switching transistor is connected to the first node; and a driving transistor, wherein a first gate electrode of the driving transistor is connected to the first node, a first electrode of the driving transistor is connected to a first power supply, a second electrode of the driving transistor is connected to the anode electrode of the OLED, and a second gate electrode of the driving transistor is connected to a common voltage line.

The driving transistor may be a double gate transistor comprising a first gate electrode and a second gate electrode.

According to another aspect of the present invention, a threshold voltage of the driving transistor may be adjusted according to an amplitude of a common voltage applied to the second gate electrode via the common voltage line.

The second gate electrode may be formed of a common electrode.

The first gate electrode may be a bottom gate electrode, and the second gate electrode may be a top gate electrode.

According to another aspect of the present invention, the switching transistor and the driving transistor may be NMOS (n-type metal-oxide-semiconductor) transistors.

According to another aspect of the present invention, there is provided an organic light emitting display apparatus comprising: a scanning driving unit supplying a scanning signal to scanning lines; a data driving unit supplying a data signal to data lines; a plurality of pixel circuits that are arranged at positions where the scanning lines and the data lines cross one another; and a common voltage applying unit applying a common voltage via a common voltage line to control brightness of light emitted from each of the pixel circuits, wherein each of the pixel circuits comprises: an organic light emitting diode (OLED); a capacitor, wherein a first terminal of the capacitor is connected to a first node, and a second terminal of the capacitor is connected to an anode electrode of the OLED; a switching transistor, wherein a gate electrode of the switching transistor is connected to a scanning line, a first electrode of the switching transistor is connected to a data line, and a second electrode of the switching transistor is connected to the first node; and a driving transistor, wherein a first gate electrode of the driving transistor is connected to the first node, and a first electrode of the driving transistor is connected to a first power supply, and a second electrode of the driving transistor is connected to the anode electrode of the OLED, and a second gate electrode of the driving transistor is connected to a common voltage line.

The common voltage applying unit may adjust an amount of current supplied to the OLED according to an amplitude of a common voltage applied to the second gate electrode via the common voltage line.

According to another aspect of the present invention, the organic light emitting display apparatus may further comprise: a current sensing unit sensing an amount of current supplied to the OLED; and a brightness control signal generating unit generating a brightness control signal according to the sensed amount of current, wherein the common voltage applying unit applies a common voltage according to the brightness control signal, to the common voltage line.

The driving transistor may be a double gate transistor comprising the first gate electrode and the second gate electrode.

A threshold voltage of the driving transistor may be adjusted according to a common voltage applied to the top gate electrode via the common voltage line.

According to another aspect of the present invention, there is provided a method of adjusting brightness of an organic light emitting display apparatus that drives an OLED by using a driving transistor including a first gate electrode and a second gate electrode, the method comprising: applying a predetermined data signal to the first gate electrode; sensing an amount of current supplied to the OLED; comparing the sensed amount of current and an amount of current according to a target brightness and generating a brightness control signal according to a result of the comparison; and applying a common voltage according to the brightness control signal, to the second gate electrode.

A threshold voltage of the driving transistor may be moved according to an amplitude of the applied common voltage.

An amount of current supplied to the OLED may be varied as the threshold voltage of the driving transistor is moved.

According to another aspect of the present invention, the second gate electrode may be formed of a common electrode of the organic light emitting display apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual diagram illustrating an organic light emitting diode (OLED), according to an embodiment of the present invention;

FIG. 2 is a circuit diagram of a pixel circuit representing an aspect of a voltage driving method, according to an embodiment of the present invention;

FIG. 3 is a conceptual diagram illustrating an organic light emitting display apparatus according to an embodiment of the present invention;

FIGS. 4A through 4C are diagrams of a driving transistor of the pixel circuit illustrated in FIG. 3 and of a variation in a threshold voltage of the driving transistor;

FIG. 5 is a circuit diagram of the pixel circuit of FIG. 3;

FIG. 6 is a flowchart illustrating a method of controlling brightness of an organic light emitting display apparatus according to another embodiment of the present invention; and

FIG. 7 is a flowchart illustrating a method of controlling brightness of an organic light emitting display apparatus according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In general, an organic light emitting display apparatus is a display device that emits light by electrically exciting fluorescent organic compounds. In detail, the organic light emitting display apparatus is designed to form an image by driving a plurality of organic light emitting cells arranged in a matrix, by applying a voltage or a current thereto. The organic light emitting cells are referred to as organic light emitting diodes (OLED) due to their diode characteristics.

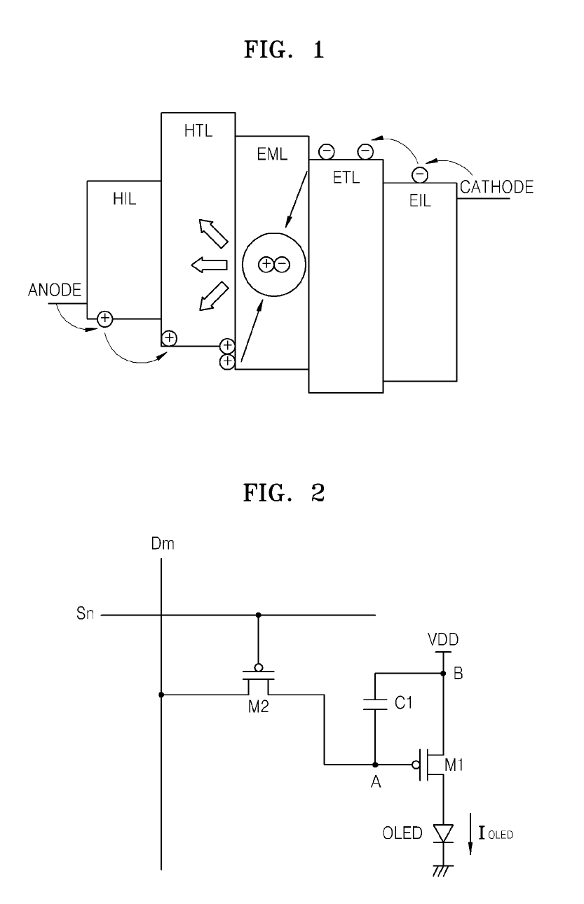

FIG. 1 is a conceptual diagram of an OLED. Referring to FIG. 1, the OLED includes an anode (ITO), an organic thin layer, and a cathode electrode layer (formed of a metal). The organic thin layer includes an emitting layer (EML), an electron transport layer (ETL), and a hole transport layer (HTL) for increasing light emitting efficiency by balancing the amounts of electrons and holes. The organic thin layer may further include a hole injecting layer (HIL) or an electron injecting layer (EIL).

The organic light emitting cells may be driven using a passive matrix method or an active matrix method using a thin film transistor (TFT) or a metal-oxide-semiconductor field effect transistor (MOSFET). In the passive matrix method, an anode and a cathode are arranged to perpendicularly cross each other and a line is selected to drive the organic light emitting cells. On the other hand, in the active matrix method, a TFT is connected to an indium tin oxide (ITO) pixel electrode and the organic light emitting cells are driven according to a voltage that is maintained according to a capacity of a capacitor connected to a gate of the TFT. An example of the active matrix method is a voltage driving method in which a signal applied to a pixel circuit to charge the capacitor and maintain the charged voltage is a voltage type signal.

FIG. 2 is a circuit diagram of a pixel circuit representing an aspect of a voltage driving method, according to an embodiment of the present invention.

Referring to FIG. 2, a switching transistor M2 is turned on according to a selection signal of a selection scanning line Sn, and a data voltage from a data line Dm is transmitted to an end of a gate of a driving transistor M1 as the switching transistor M2 is turned on, and a potential difference between the data voltage and a voltage source VDD is stored in a capacitor C1 connected between the gate and a source of the driving transistor M1. Due to the potential difference, a driving current I_{OLED} is applied to the OLED, and thus light is emitted from the OLED. A predetermined gradation of brightness may be expressed according to a voltage level of the above-applied data voltage.

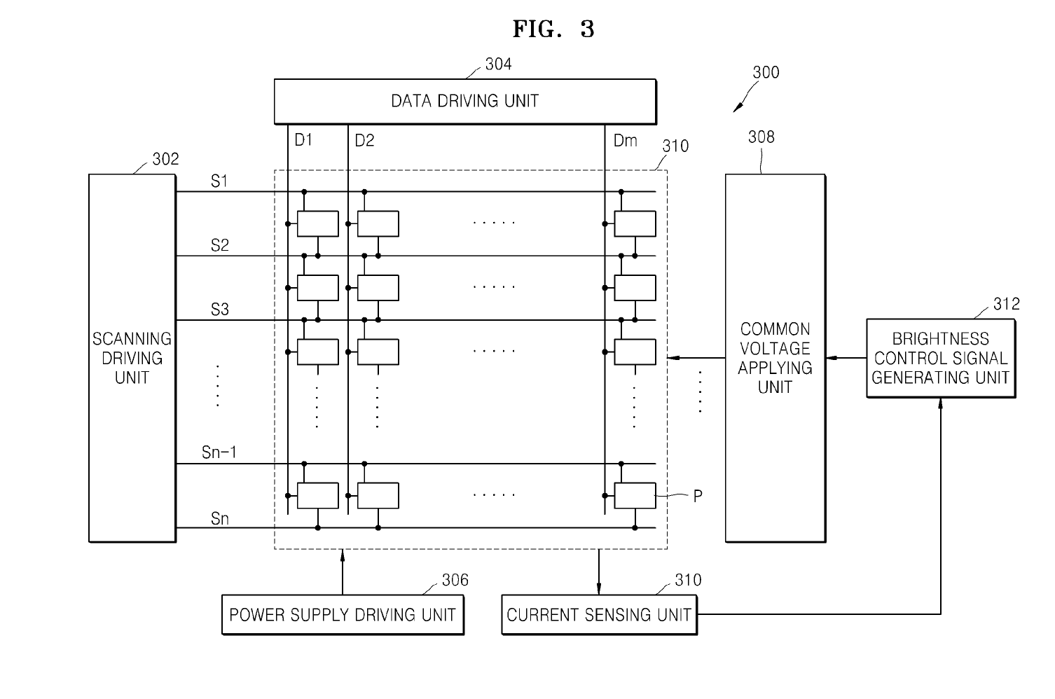

FIG. 3 is a conceptual diagram illustrating an organic light emitting display apparatus 300 according to an embodiment of the present invention. Referring to FIG. 3, the organic light emitting display apparatus 300 includes a pixel unit 310, a scanning driving unit 302, a data driving unit 304, a power supply driving unit 306, a common voltage applying unit 308, a current sensing unit 310, and a brightness control signal generating unit 312.

The pixel unit 310 includes n×m pixel circuits P each including an OLED (not shown), n scanning lines S1, S2, . . . , Sn that are arranged horizontally and transmit a scanning signal, m data lines D1, D2, . . . , Dm that are arranged vertically and transmit a data signal, and m first power lines (not shown) and m second power lines (not shown) that transmit power.

The pixel unit 310 forms an image by emitting light using an OLED (not shown) according to a scanning signal, a data signal, a first power supply ELVDD, and a second power supply ELVSS.

The scanning driving unit 302 is connected to the scanning lines S1, S2, . . . , Sn and applies a scanning signal to the pixel unit 310.

The data driving unit 304 is connected to the data lines D1, D2, . . . , Dm and applies a data signal to the pixel unit 310. The data driving unit 304 supplies a data signal to the plurality of pixel circuits P during a programming period.

The power supply driving unit 306 supplies power from the first power supply ELVDD and the second power supply ELVSS to each of the pixel circuits P.

The common voltage applying unit 308 supplies a common voltage Vcom to the pixel circuits P. The common voltage applying unit 308 supplies a common voltage Vcom to a top gate electrode of the driving transistor of the pixel circuit P which is formed of a double gate electrode. The common voltage to be applied to the top gate electrode is determined according to an amount of variation of a threshold voltage of the driving transistor. That is, the amount of current flowing to the OLED is varied according to the variation in the threshold voltage, and a brightness level of the organic light emitting display apparatus 300 is controlled according to the amount of current.

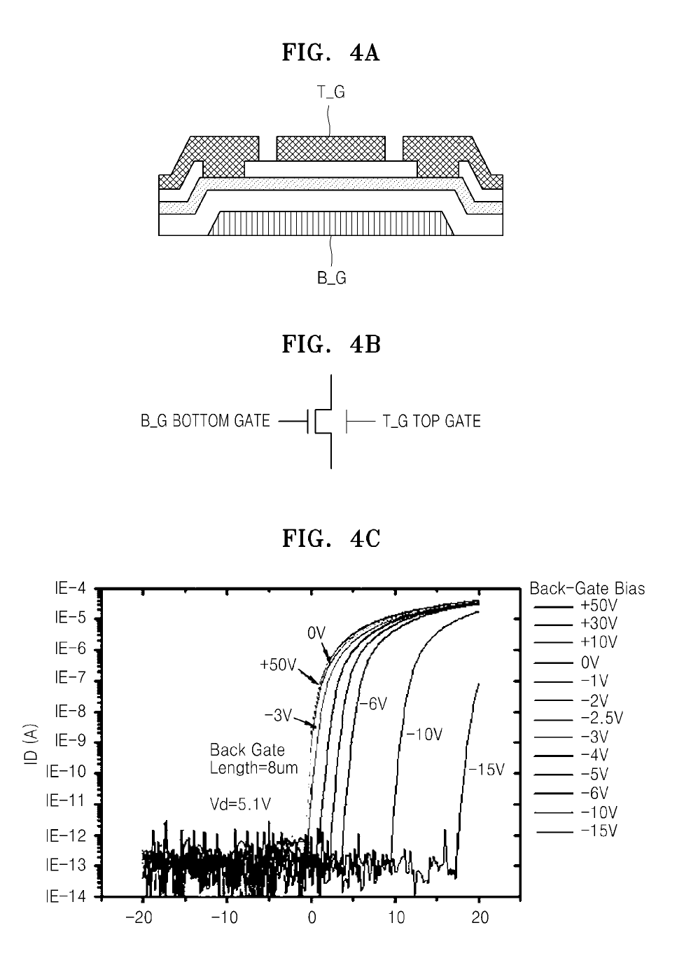

FIGS. 4A and 4B are diagrams of a driving transistor of the pixel circuits P illustrated in FIG. 3. As illustrated in FIG. 4A, the driving transistor of the pixel circuits P includes a top gate electrode T_G and a bottom gate electrode B_G. In FIG. 4A, a double gate electrode structure is illustrated, and in FIG. 4B, a top gate electrode T_G and a bottom gate electrode B_G are illustrated. FIG. 4C illustrates variation in a threshold voltage of the driving transistor according to a voltage applied to the top gate electrode T_G of FIG. 4B.

Hereinafter, for convenience of description, a bottom gate electrode of the double gate electrode will be referred to as a first gate electrode, and a top gate electrode will be referred to as a second gate electrode.

As illustrated in FIG. 4C, the threshold voltage is changed to a positive voltage according to a voltage applied to the top gate electrode or a second gate electrode. For example, when a voltage of −10 V is applied to the top gate electrode, the threshold voltage is about 10 V, and when a voltage of −6 V is applied, the threshold voltage drops to about 4 V. Based on this result, if the threshold voltage at an initial stage of manufacturing a panel may be measured, and if the threshold voltage is a predetermined negative voltage, the threshold voltage is changed to a positive voltage by applying the predetermined negative voltage to the top gate, thereby controlling the amount of driving current due to threshold voltage compensation and threshold voltage variation according to time.

The brightness control signal generating unit 312 generates a brightness control signal to provide the same to the common voltage applying unit 308. The brightness control signal generating unit 312 generates a brightness control signal and provides the same to the common voltage applying unit 308 when a current amount supplied to the OLED needs to be varied.

The current sensing unit 310 senses a driving current of the pixel circuits P, that is, a current that drives the OLED to obtain a predetermined brightness. The amount of sensed driving current is provided to the brightness control signal generating unit 312.

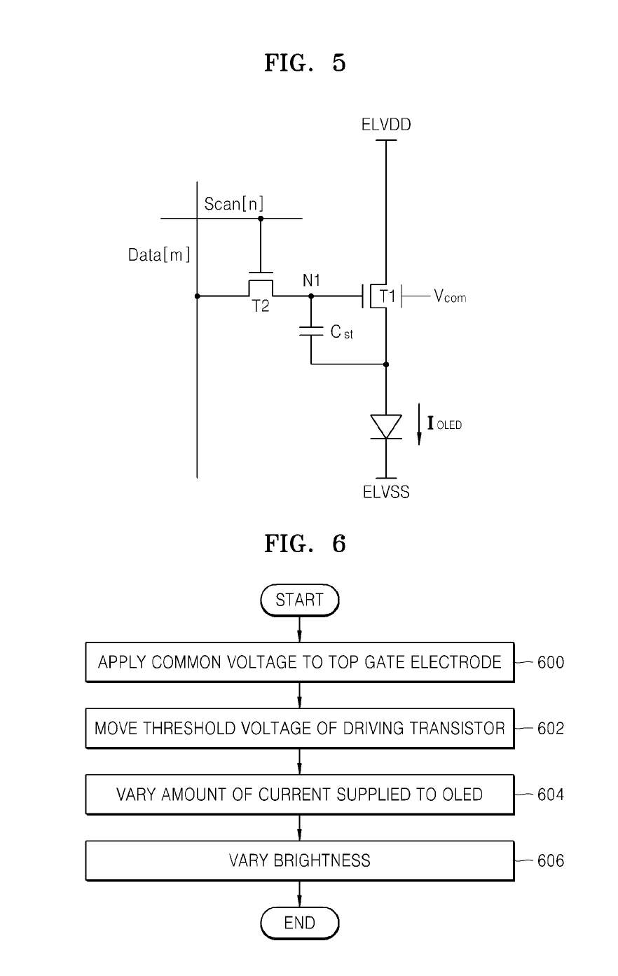

FIG. 5 is a circuit diagram of one of the pixel circuits P of FIG. 3. In FIG. 5, the pixel circuit P includes an N-th scanning line Scan[n] and an M-th data line data[m].

An anode electrode of the OLED is connected to a source electrode of a first transistor T1, and a cathode electrode is connected to the second power supply ELVSS. The OLED emits light of predetermined brightness in correspondence with the amount of current supplied to the first transistor T1, that is, a driving transistor.

A first terminal of a capacitor Cst is connected to the anode electrode of the OLED, and a second terminal of the capacitor Cst is connected to a first node N1. The capacitor Cst charges a voltage of the first node N1 during a data writing period.

A gate electrode of a second transistor T2 is connected to the (N-th) scanning line Scan[n], a first electrode of the second transistor T2 is connected to the (M-th) data line Data[m], and a second electrode of the second transistor T2 is connected to the first node N1. A scanning signal, that is, a high level signal, is applied from the scanning line Scan[n] to the gate electrode of the second transistor T2, and the second transistor T2 is turned on, and thus a predetermined data signal is transmitted to the first node N1.

A bottom gate electrode of the first transistor T1 is connected to the first node N1, and a first electrode thereof is connected to the first power supply ELVDD, and a second electrode thereof is connected to the anode electrode of the OLED. A top gate electrode of the first transistor T1 is connected to a common voltage line Vcom. A common voltage is applied to the top gate electrode via the common voltage line Vcom. Also, the top gate electrode of the first transistor T1 may selectively be a common electrode, and a common voltage may be applied via the common electrode.

A current applied to the OLED is determined by a difference between a voltage of the gate electrode, that is, the bottom gate electrode of the first transistor T1, which is the driving transistor, and a voltage of a source electrode.

A current I_{OLED} applied to the OLED is as represented in Equation 1 below.

I_{OLED}=K(V_{gs}−Vₜₕ)² <Equation 1>

where K is a constant number determined by mobility and parasitic capacity of the driving transistor, and Vgs is a voltage difference between a bottom gate and a source electrode of the driving transistor, and Vth is a threshold voltage of the driving transistor. The threshold voltage Vth of the driving transistor is varied according to the amplitude of a common voltage Vcom applied to the top gate electrode. A driving current I_{OLED} may be changed not only by the voltage difference Vgs but also by the common voltage Vcom. Accordingly, by adjusting the threshold voltage Vth of the driving transistor in a display panel, brightness of the display panel may be adjusted, thereby realizing an auto brightness control (ABC) function.

According to the current embodiment of the present invention, the switching transistor T2 and the driving transistor T1 are n-type metal oxide semiconductor (NMOS) transistors, which are turned on when a control signal is at a high level, and turned off when a control signal is at a low level. According to the current embodiment of the present invention, the pixel circuit P is an NMOS transistor but may also be a PMOS transistor or a CMOS transistor.

FIG. 6 is a flowchart illustrating a method of controlling brightness of an organic light emitting display apparatus according to another embodiment of the present invention.

Referring to FIG. 6, in operation 600, a common voltage is applied to a top gate electrode. The amplitude of the applied common voltage may be determined arbitrarily. In operation 602, a threshold voltage of a driving transistor is varied. As described above, the threshold voltage is varied according to the amplitude of a voltage applied to the top gate electrode of the driving transistor having a double gate structure. In operation 604, the amount of current supplied to an OLED is varied. A threshold voltage is varied according to the amplitude of the common voltage applied according to Equation 1, and a driving current I_{OLED} is also varied accordingly. In operation 606, brightness of light emitted from the OLED varies according to the amount of driving current I_{OLED}.

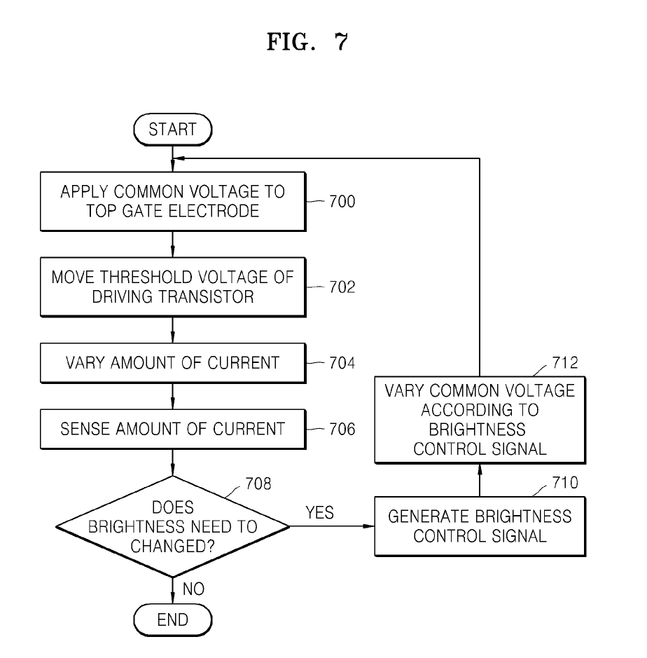

FIG. 7 is a flowchart illustrating a method of controlling brightness of an organic light emitting display apparatus according to another embodiment of the present invention.

Referring to FIG. 7, in operation 700, a common voltage is applied to a top gate electrode. In operation 702, a threshold voltage of a driving transistor is varied. In operation 704, the amount of current varies. In operation 706, the amount of current is sensed. The varied amount of current may be sensed from each of the pixels. In operation 708, whether brightness needs to be changed or not is determined. That is, whether an ABC function needs to be performed is determined. In operation 710, a brightness control signal is generated if brightness needs to be changed. In operation 712, the common voltage is varied according to the brightness control signal. In operation 700, the varied common voltage is applied to the top gate.

According to the embodiments of the present invention, a common voltage is applied to a second gate electrode of a driving transistor which is formed of a double gate structure to control a current applied to an organic light emitting diode (OLED), thereby realizing an auto brightness control (ABC) function.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A pixel circuit comprising:
an organic light emitting diode (OLED);
a capacitor, wherein a first terminal of the capacitor is connected to a first node, and a second terminal of the capacitor is connected to an anode electrode of the OLED;
a switching transistor, wherein a gate electrode of the switching transistor is connected to a scanning line, a first electrode of the switching transistor is connected to a data line, and a second electrode of the switching transistor is connected to the first node; and
a driving transistor, wherein a first gate electrode of the driving transistor is connected to the first node, a first electrode of the driving transistor is connected to a first power supply, a second electrode of the driving transistor is connected to the anode electrode of the OLED, and a second gate electrode of the driving transistor is connected to a common voltage line.

2. The pixel circuit of claim 1, wherein the driving transistor is a double gate transistor comprising the first gate electrode and the second gate electrode.

3. The pixel circuit of claim 1, wherein a threshold voltage of the driving transistor is adjusted according to an amplitude of a common voltage applied to the second gate electrode via the common voltage line.

4. The pixel circuit of claim 1, wherein the second gate electrode is part of a common electrode.

5. The pixel circuit of claim 1, wherein the first gate electrode of the driving transistor is a bottom gate electrode, and the second gate electrode of the driving transistor is a top gate electrode.

6. The pixel circuit of claim 1, wherein the switching transistor and the driving transistor are NMOS (n-type metal-oxide-semiconductor) transistors.

7. An organic light emitting display apparatus comprising:
a scanning driving unit supplying a scanning signal to scanning lines;
a data driving unit supplying a data signal to data lines;
a plurality of pixel circuits that are arranged at positions where the scanning lines and the data lines cross one another; and
a common voltage applying unit applying a common voltage via a common voltage line to control brightness of light emitted from each of the pixel circuits,
wherein each of the pixel circuits comprises:
an organic light emitting diode (OLED);
a capacitor, wherein a first terminal of the capacitor is connected to a first node, and a second terminal of the capacitor is connected to an anode electrode of the OLED;
a switching transistor, wherein a gate electrode of the switching transistor is connected to a scanning line, a first electrode of the switching transistor is connected to a data line, and a second electrode of the switching transistor is connected to the first node; and
a driving transistor, wherein a first gate electrode of the driving transistor is connected to the first node, and a first electrode of the driving transistor is connected to a first power supply, and a second electrode of the driving transistor is connected to the anode electrode of the OLED, and a second gate electrode of the driving transistor is connected to the common voltage line.

8. The organic light emitting display apparatus of claim 7, wherein the common voltage applying unit adjusts an amount of current supplied to the OLED according to an amplitude of the common voltage applied to the second gate electrode via the common voltage line.

9. The organic light emitting display apparatus of claim 7, further comprising:
a current sensing unit sensing an amount of current supplied to the OLED; and
a brightness control signal generating unit generating a brightness control signal according to the sensed amount of current supplied to the OLED,
wherein the common voltage applying unit applies the common voltage according to the brightness control signal, to the common voltage line.

10. The organic light emitting display apparatus of claim 7, wherein the driving transistor is a double gate transistor comprising the first gate electrode and the second gate electrode.

11. The organic light emitting display apparatus of claim 7, wherein a threshold voltage of the driving transistor is adjusted according to the common voltage applied to the top gate electrode of the driving transistor via the common voltage line.

12. A method of adjusting brightness of an organic light emitting display apparatus that drives an OLED by using a driving transistor including a first gate electrode and a second gate electrode, the method comprising:
applying a predetermined data signal to the first gate electrode of the driving transistor;
sensing an amount of current supplied to the OLED;
comparing the sensed amount of current supplied to the OLED and an amount of current according to a target brightness and generating a brightness control signal according to a result of the comparison; and
applying a common voltage to the second gate electrode according to the brightness control signal.

13. The method of claim 12, wherein a threshold voltage of the driving transistor is varied according to an amplitude of the applied common voltage.

14. The method of claim 13, wherein an amount of current supplied to the OLED is varied as the threshold voltage of the driving transistor is varied.

15. The method of claim 12, wherein the second gate electrode of the driving transistor is formed of a common electrode of the organic light emitting display apparatus.

16. The pixel circuit of claim 1, wherein a common voltage is applied to the second gate electrode of the driving transistor to control a current applied to the OLED and adjust a brightness of the OLED.
